(19) United States
(12) Patent Application Publication
(10) Pub. No.: US 2026/0115902 A1
(43) Pub. Date: Apr. 30, 2026

(54) ARTIFICIAL INTELLIGENCE DEVICE, ITS METHOD OF OPERATION AND RECORDING MEDIUM

(71) Applicant: LG ELECTRONICS INC., Seoul (KR)

(72) Inventors: Jaehong Kim, Seoul (KR); Jaewook Lee, Seoul (KR); Seheon Choi, Seoul (KR); Hyoeun Kim, Seoul (KR); Yoonsik Kim, Seoul (KR); Yeonjee Jung, Seoul (KR); Hyungho Jung, Seoul (KR); Junesup Yi, Seoul (KR); Dahyun Kim, Seoul (KR); Yubin Cho, Seoul (KR); Hyejeong Jeon, Seoul (KR)

(73) Assignee: LG ELECTRONICS INC., Seoul (KR)

(21) Appl. No.: 19/363,020

(22) Filed: Oct. 20, 2025

(30) Foreign Application Priority Data
Oct. 31, 2024 (WO) PCT/KR2024/016907

(51) Int. Cl. B25J 9/16

(52) U.S. Cl. CPC B25J 9/161; B25J 9/1697

(57) ABSTRACT

An artificial intelligence device according to an embodiment of the present disclosure may comprise a memory configured to store a plurality of action plan templates; and at least one processor configured to: obtain a command and an initial image, obtain an action plan template among the plurality of action plan templates based on the obtained command and initial image, generate a robot control command from the command, the initial image and the obtained action plan template, and control both arms of a robot through the generated robot control command.

### CROSS-REFERENCE TO RELATED APPLICATION

Pursuant to 35 U.S.C. § 119(a), this application claims priority to PCT Application No. PCT/KR2024/016907, filed on Oct. 31, 2024, the entity of which is incorporated by reference into the present application.

### BACKGROUND OF THE INVENTION

### 1.field of the Invention

The present invention relates to an artificial intelligence device, and more specifically, to an artificial intelligence device capable of controlling an operation of a robot.

### 2. Discussion of the Related Art

The development of artificial intelligence (AI) robots has advanced rapidly, and innovative changes are expected to continue in the future. The development of AI robots is having a significant impact across technology, society, and the economy.

AI robots have both arms, and object control by AI robots with both arms is very complex and difficult. Users want AI robots to behave similarly to humans.

However, for all objects in the world, too much data for each object is needed to achieve human-like arm movements.

Additionally, if the motion sequence of each arm is not defined, there is a problem in that it is difficult for the robot to actually move.

### SUMMARY OF THE INVENTION

The purpose of the present disclosure is to establish an action plan for two arms so that an artificial intelligence robot may follow movements similar to how a person acts.

The purpose of the present disclosure is to enable an artificial intelligence robot to accurately perform sequential actions based on an action plan template created based on a human demonstration video.

An artificial intelligence device according to an embodiment of the present disclosure may comprise a memory configured to store a plurality of action plan templates; and at least one processor configured to: obtain a command and an initial image, obtain an action plan template among the plurality of action plan templates based on the obtained command and initial image, generate a robot control command from the command, the initial image and the obtained action plan template, and control both arms of a robot through the generated robot control command.

A method of operating an artificial intelligence device according to an embodiment of the present disclosure may comprise storing a plurality of action plan templates; obtaining a command and an initial image; obtaining an action plan template among the plurality of action plan templates based on the obtained command and initial image; generating a robot control command from the command, the initial image and the obtained action plan template; and controlling both arms of a robot through the generated robot control command.

A computer-readable non-transitory recording medium on which a program for performing a method of operating an artificial intelligence device is recorded according to an embodiment of the present disclosure, wherein the method comprises:
storing a plurality of action plan templates; obtaining a command and an initial image; obtaining an action plan template among the plurality of action plan templates based on the obtained command and initial image; generating a robot control command from the command, the initial image and the obtained action plan template; and controlling both arms of a robot through the generated robot control command.

According to an embodiment of the present disclosure, an artificial intelligence robot may operate in a manner similar to the manner in which a person operates. Accordingly, tasks that should be performed by humans may be performed by artificial intelligence robots, greatly improving task automation, productivity, and stability.

According to an embodiment of the present disclosure, the accuracy of task performance of an artificial intelligence robot may be greatly improved as its movements are controlled in a manner similar to the method performed by humans.

According to an embodiment of the present disclosure, automatic control of a robot may be easily achieved with only simple command and initial image.

### BRIEF DESCRIPTION OF THE DRAWINGS

FIG. 1 is a block diagram for illustrating elements of an artificial intelligence device according to an embodiment of the present disclosure.

FIG. 2 is a diagram for illustrating the configuration of an artificial intelligence server according to an embodiment of the present disclosure.

FIG. 3 is a diagram for explaining a configuration of an artificial intelligence robot according to an embodiment of the present disclosure.

FIG. 4 is a flowchart for explaining a method of operating an artificial intelligence device according to an embodiment of the present disclosure.

FIGS. 5 to 8 are diagrams for explaining a method of constructing an action plan template according to an embodiment of the present disclosure.

FIGS. 9 and 10 are diagrams illustrating a process for obtaining a modified action plan template corresponding to an instruction and an initial image according to an embodiment of the present disclosure.

FIGS. 11A to 11G are diagrams illustrating a process in which an artificial intelligence robot performs a task according to robot control commands and action trajectory information.

### DETAILED DESCRIPTION OF THE EMBODIMENTS

Artificial intelligence refers to the field of researching artificial intelligence or methodology to create it, and machine learning refers to the field of defining various problems dealt with in the field of artificial intelligence and researching methodology to solve them.

Machine learning is also defined as an algorithm that improves the performance of a task through consistent experience.

Artificial Neural Network (ANN) is a model used in machine learning, it may refer to an overall model with problem-solving capability that is composed of artificial neurons (nodes) that form a network through the combination of synapses.

Artificial neural network may be defined by connection pattern between neurons in different layers, a learning process that updates model parameter, and an activation function that generates output value.

An artificial neural network may include an input layer, an output layer, and optionally one or more hidden layers. Each layer may include one or more neurons, and the artificial neural network may include synapse connecting neurons. In an artificial neural network, each neuron may output the input signals input through the synapse, weight, and value of activation function for bias.

Model parameter refer to a parameter determined through learning and includes the weight of synapse connection and the bias of neurons. Hyperparameter refer to a parameter that must be set before learning in a machine learning algorithm and includes learning rate, number of repetition, mini-batch size, initialization function, etc.

The purpose of learning an artificial neural network may be seen as determining model parameter that minimize the loss function. The loss function may be used as an indicator to determine optimal model parameter during the learning process of an artificial neural network.

Machine learning may be classified into supervised learning, unsupervised learning, and reinforcement learning depending on the learning method.

Supervised learning refers to a method of training an artificial neural network with a label for the learning data given, a label may mean the correct answer (or result value) that the artificial neural network must infer when learning data is input to the artificial neural network.

Unsupervised learning may refer to a method of training an artificial neural network in a state where no label for training data is given.

Reinforcement learning may refer to a learning method in which an agent defined within an environment learns to select an action or action sequence that maximizes the cumulative reward in each state.

Among artificial neural networks, machine learning implemented with a deep neural network (DNN) that includes multiple hidden layers is also called deep learning, and deep learning is a part of machine learning.

Hereinafter, machine learning is used to include deep learning.

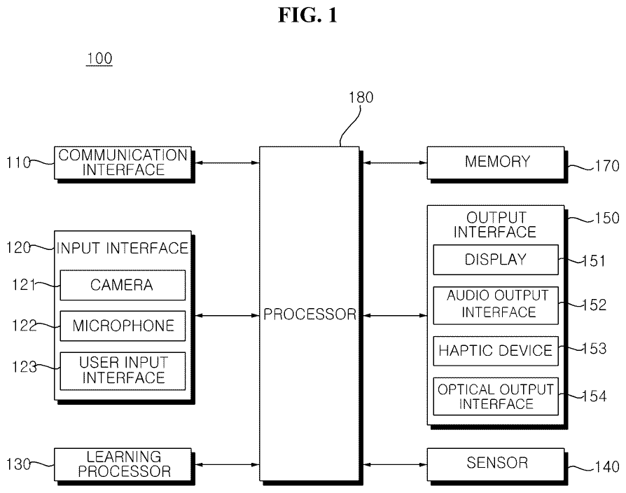

FIG. 1 is a block diagram for illustrating elements of an artificial intelligence device according to an embodiment of the present disclosure.

The artificial intelligence device 100 may be implemented as a fixed or movable device such as a TV, a projector, a mobile phone, a smartphone, a desktop computer, a laptop, a digital broadcasting terminal, a PDA (personal digital assistant), a PMP (portable multimedia player), a navigation, a tablet PC, a wearable device, and a set-top box (STB), a DMB receiver, a radio, a washing machine, a refrigerator, a desktop computer, a digital signage, a robot, a vehicle, etc.

Referring to FIG. 1, the artificial intelligence device 100 may include a communication interface 110, an input interface 120, a learning processor 130, a sensor 140, an output interface 150, a memory 170, and a processor 180.

The communication interface 110 may transmit and receive data with external device such as other artificial intelligence device or the AI server 200 using wired or wireless communication technology. For example, the communication interface 110 may transmit and receive sensor information, user input, learning model, and control signal with external device.

Communication technologies used by the communication interface 110 include Global System for Mobile communication (GSM), Code Division Multi Access (CDMA), Long Term Evolution (LTE), 5G, Wireless LAN (WLAN), and Wireless-Fidelity (Wi-Fi), Bluetooth (Bluetooth), RFID (Radio Frequency Identification), Infrared Data Association (IrDA), ZigBee, NFC (Near Field Communication), etc.

The input interface 120 may acquire various types of data.

The input interface 120 may include a camera 121 for capturing image, a microphone 122 for receiving audio signals, and a user input interface 123 for receiving information from a user.

The camera 121 or the microphone 122 is treated as a sensor, and the signal obtained from the camera 121 or the microphone 122 may be called sensing data or sensor information.

The input interface 120 may obtain training data for model learning and input data to be used when obtaining an output using the learning model. The input interface 120 may acquire unprocessed input data, and in this case, the processor 180 or the learning processor 130 may extract input feature by preprocessing the input data.

The camera 121 processes image frame such as still image or moving image obtained by an image sensor in video call mode or photographing mode. Processed image frame may be displayed on display 151 or stored in memory 170.

The microphone 122 processes external acoustic signal into electrical voice data. The processed voice data may be utilized in various ways depending on the function (or application being executed) being performed by the artificial intelligence device 100. Meanwhile, various noise removal algorithms may be applied to the microphone 122 to remove noise generated in the process of receiving an external acoustic signal.

The user input interface 123 is for receiving information from the user, when information is input through the user input interface 123, the processor 180 may control the operation of the artificial intelligence device 100 to correspond to the input information.

The user input interface 123 is a mechanical input means (or mechanical key, for example, a button, dome switch, jog wheel, or jog switch located on the front/rear or side of the artificial intelligence device 100). etc.) and a touch input means.

As an example, the touch input may consist of a virtual key, soft key, or visual key displayed on the touch screen through software processing, or a touch key placed in a part other than the touch screen.

The learning processor 130 may train a model composed of an artificial neural network using training data. The learned artificial neural network may be referred to as a learning model. A learning model may be used to infer a result value for new input data other than learning data, and the inferred value may be used as the basis for a decision to perform an operation.

The learning processor 130 may perform AI processing together with the learning processor 240 of the AI server 200.

The learning processor 130 may include memory integrated or implemented in artificial intelligence device 100. The learning processor 130 may be implemented using the memory 170, an external memory directly coupled to the artificial intelligence device 100, or a memory maintained in an external device.

The sensor 140 may obtain at least one of internal information of the artificial intelligence device 100, information on the surrounding environment of the artificial intelligence device 100, or user information using various sensors.

The sensor 140 may include at least one of a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar sensor, or a radar sensor.

The output interface 150 may generate output related to vision, hearing, or tactile sensation.

The output interface 150 may include a display 151 that outputs an image, an audio output interface 152 that outputs audio, a haptic device 153 that outputs tactile information, and an optical output interface 154 that outputs light.

The display 151 displays (outputs) information processed by the artificial intelligence device 100. For example, the display 151 may display execution screen information of an application running on the artificial intelligence device 100, or user interface (UI) and graphic user interface (GUI) information according to the execution screen information.

The display 151 may be implemented as a touch screen by forming a mutual layer structure or being integrated with the touch sensor. The touch screen functions as a user input interface 123 that provides an input interface between the artificial intelligence device 100 and the user, and may simultaneously provide an output interface between the artificial intelligence device 100 and the user.

The audio output interface 152 may output audio data received from the communication interface 110 or stored in the memory 170 in call signal reception, call mode or recording mode, voice recognition mode, broadcast reception mode, etc.

The audio output interface 152 may include at least one of a receiver, a speaker, or a buzzer.

The haptic device 153 generates various tactile effects that the user may feel. A representative example of a tactile effect generated by the haptic device 153 may be vibration.

The light output interface 154 uses light from the light source of the artificial intelligence device 100 to output a signal to notify that an event has occurred. Examples of events that occur in the artificial intelligence device 100 may include receiving a message, receiving a call signal, a missed call, an alarm, a schedule notification, receiving an email, receiving information through an application, etc.

The memory 170 may store data supporting various functions of the artificial intelligence device 100. For example, the memory 170 may store input data obtained from the input interface 120, learning data, learning model, learning history, etc.

The processor 180 may determine at least one executable operation of the artificial intelligence device 100 based on information determined or generated using a data analysis algorithm or a machine learning algorithm.

The processor 180 may control the elements of the artificial intelligence device 100 to perform the determined operation.

To this end, the processor 180 may request, search, receive, or utilize data from the learning processor 130 or the memory 170, and may control elements of the artificial intelligence device 100 to be performed an operation that is predicted or an operation that is determined to be desirable among the at least one executable operation.

If linkage with an external device is necessary to perform a determined operation, the processor 180 may generate a control signal to control the external device and transmit the generated control signal to the external device.

The processor 180 may obtain intent information for user input and determine the user's request based on the obtained intent information.

The processor 180 may obtain intent information corresponding to the user input using at least one of a STT (Speech To Text) engine for converting voice input into a character string or a Natural Language Processing (NLP) engine for acquiring intent information of natural language.

At least one of the STT engine and the NLP engine may be composed of at least a portion of an artificial neural network learned according to a machine learning algorithm. And, at least one of the STT engine or the NLP engine may be learned by the learning processor 130, learned by the learning processor 240 of the AI server 200, or learned by distributed processing thereof.

The processor 180 collects history information including the user's feedback on the operation of the artificial intelligence device 100 and stores it in the memory 170 or the learning processor 130 or the AI server 200, etc. May be transmitted to external devices. The collected historical information may be used to update the learning model.

The processor 180 may control at least some of the elements of the artificial intelligence device 100 to run an application program stored in the memory 170.

The processor 180 may operate two or more of the elements included in the artificial intelligence device 100 in combination with each other in order to run the application program.

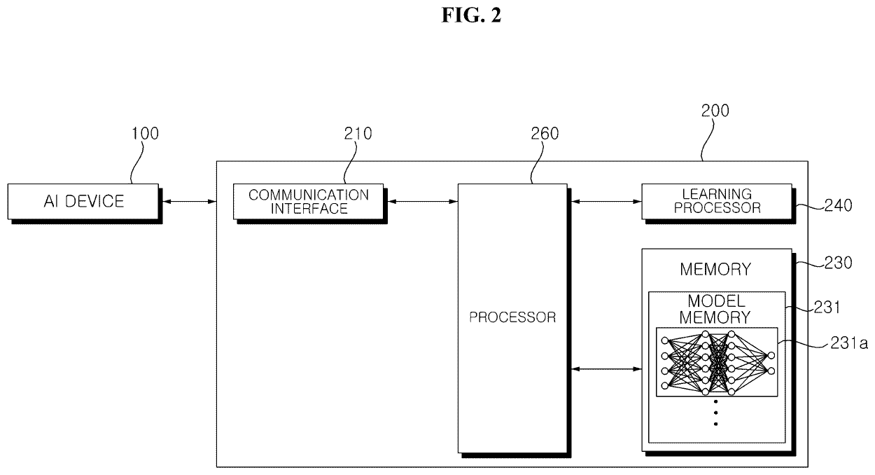

FIG. 2 is a diagram for illustrating the configuration of an artificial intelligence server according to an embodiment of the present disclosure.

Referring to FIG. 2, the AI server 200 may refer to a device that trains an artificial neural network using a machine learning algorithm or uses a learned artificial neural network.

The AI server 200 may be composed of a plurality of servers to perform distributed processing, and may be defined as a 5G network. The AI server 200 may be included as a part of the artificial intelligence device 100 and may perform at least part of the AI processing.

The AI server 200 may include a communication interface 210, a memory 230, a learning processor 240, and a processor 260.

The communication interface 210 may transmit and receive data with an external device such as the artificial intelligence device 100.

The memory 230 may include a model memory 231. The model memory 231 may store a model (or artificial neural network, 231a) that is being trained or has been learned through the learning processor 240.

The learning processor 240 may train the artificial neural network 231a using training data. The learning model may be used while mounted on the AI server 200 of the artificial neural network, or may be mounted and used on an external device such as the artificial intelligence device 100.

The learning model may be implemented in hardware, software, or a combination of hardware and software. When part or all of the learning model is implemented as software, one or more instructions constituting the learning model may be stored in the memory 230.

The processor 260 may infer a result value for new input data using a learning model and generate a response or control command based on the inferred result value.

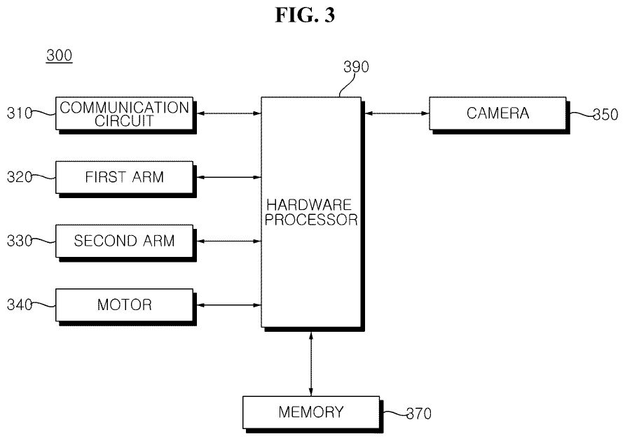

FIG. 3 is a diagram for explaining a configuration of an artificial intelligence robot according to an embodiment of the present disclosure.

Referring to FIG. 3, the artificial intelligence robot 300 may include a communication circuit 310, a first arm 320, a second arm 330, a motor 340, a camera 350, a memory 370, and a hardware processor 390.

The communication circuit 310 may transmit and receive data with external devices such as the artificial intelligence device 100 or the AI server 200 using wired or wireless communication technology. For example, the communication interface 110 may transmit and receive sensor information, user input, learning model, and control signal with external devices.

Communication technologies used by the communication circuit 310 include Global System for Mobile communication (GSM), Code Division Multi Access (CDMA), Long Term Evolution (LTE), 5G, Wireless LAN (WLAN), Wireless-Fidelity (Wi-Fi), Bluetooth, Radio Frequency Identification (RFID), Infrared Data Association (IrDA), ZigBee, NFC (Near Field Communication), etc.

The first arm 320 may represent a left arm of the artificial intelligence robot 300. The first arm 320 may be referred to as a first gripper, the left arm, or a lead arm.

The second arm 330 may represent a right arm of the artificial intelligence robot 300. The second arm 330 may be referred to as a second gripper, the right arm, or a follow arm.

The motor 340 may control an operation of the first arm 320 and the second arm 330. One or more motors (340) may be provided.

The motor 340 may include a first sub-motor for controlling the operation of the first arm 320 and a second sub-motor for controlling the operation of the second arm 330.

The camera 350 may acquire an image or a video obtained by an image sensor.

Memory 370 may store a plurality of action plan templates. The memory 370 may further store a plurality of embedding vectors corresponding to the plurality of action plan templates.

The hardware processor 390 may control an overall operation of the artificial intelligence robot 300. A plurality of hardware processors 390 may be provided.

The hardware processor 390 may perform at least some of the operations performed by the processor 180 of the artificial intelligence device 100, which will be described later.

The hardware processor 390 may control the operations of the first arm 320 and the second arm 330 according to the robot control command received from the artificial intelligence device 100.

The communication circuit 310, motor 340, camera 350, memory 370, and hardware processor 390 may be provided in the main body (not shown) of the artificial intelligence robot 300. The first arm 320 and the second arm 330 may be connected to the main body.

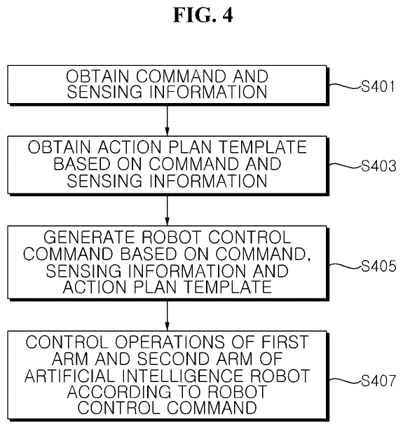

FIG. 4 is a flowchart for explaining a method of operating an artificial intelligence device according to an embodiment of the present disclosure.

Hereinafter, the artificial intelligence device 100 may be any one of terminals such as a computer, laptop, or smartphone. A plurality of processors 180 may be provided.

The processor 180 of the artificial intelligence device 100 may obtain a command and sensing information (S401).

In one embodiment, the command may be a command instructing the operation of the artificial intelligence robot 300. In particular, the command may be a command instructing the operation of the first arm 320 and the second arm 330 provided in the artificial intelligence robot 300.

In one embodiment, the command may be either a text instruction or an audio instruction.

In one embodiment, the sensing information may include one or more of an image, a distance between an object obtained from a distance measurement sensor and the artificial intelligence robot 300, or a temperature measured through a temperature sensor. The sensing information may be referred to as observation information.

The image may be acquired by either the camera 121 provided in the artificial intelligence device 100 or the camera 350 provided in the artificial intelligence robot 300.

The image may be an initial image taken corresponding to a position where the head of the artificial intelligence robot 300 is looking.

The processor 180 of the artificial intelligence device 100 may obtain an action plan template based on the obtained command and sensing information (S403).

The processor 180 may call the action plan template that matches the obtained command and sensing information among the plurality of action plan templates.

The memory 170 of the artificial intelligence device 100 may store the plurality of action plan templates. Memory 170 may be referred to as a database.

The processor 180 may generate the action plan template based on the instruction and a human demonstration video.

Below we explain how to build the action plan template.

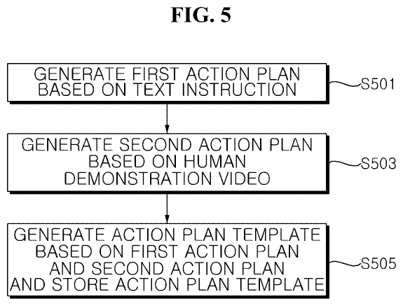

FIGS. 5 to 8 are diagrams for explaining a method of constructing an action plan template according to an embodiment of the present disclosure.

Referring to FIG. 5, the processor 180 of the artificial intelligence device 100 may generate a first action plan based on a text instruction (S501).

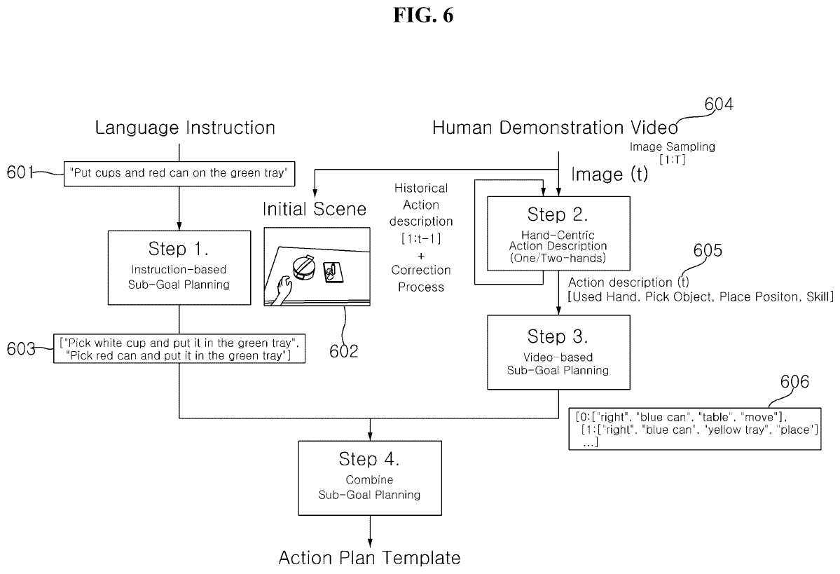

The processor 180 may obtain the text instruction through the user input interface 123. The text instruction 601 may be an instruction of a text type such as <put cups and red may on the green tray> as shown in FIG. 6.

The processor 180 may generate a text-based first action plan 603 based on the text instruction 601 and an initial sampling image 602. The initial sampling image 602 may be sampled from a human demonstration video 604. The initial sampled image 602 may be an image sampled at an early point in the human demonstration video 604.

The first action plan 603 may be a plan that specifically describes the text instruction 601. As shown in FIG. 6, the first action plan 603 may be a plan of the text type such as <Pick white cup and put it in the green tray, Pick red may and put it in the green tray>.

The first action plan 603 may be referred to as instruction-based sub-goal planning.

The processor 180 may obtain the first action plan 603 from the text instruction 601 and the initial sampling image 602 using a large language model (LLM) stored in the memory 170.

The LLM may be an artificial intelligence-based model that generates a response result from a text or text and images. The processor 180 may generate a prompt requesting the action plan from the text instruction 601 and the initial sampling image 602, and may input the generated prompt into the LLM. The LLM may output the first action plan 603 in response to the prompt.

In another embodiment, the LLM may be stored in the memory 230 of the AI server 200. The artificial intelligence device 100 may transmit the text instruction 601 and the initial sampling image 602 to the AI server 200 and receive the first action plan 603 from the AI server 200.

The processor 180 of the artificial intelligence device 100 may generate a second action plan based on the human demonstration video (S503).

The human demonstration video 604 may be a video containing a person directly demonstrating an action in response to a command or an instruction. For example, the human demonstration video 604 may be a video that shows a person directly moving a specific object to a specific location. The human demonstration video 604 may be recorded in advance and stored in the memory 170.

The processor 180 may perform image sampling from the human demonstration video 604. The processor 180 may obtain an action description 605 from each of a plurality of sampled images sampled from the human demonstration video 604. The action description may describe the sampling image.

The action description 605 may include an arm used for the sampling image, an object held by the used arm, a location where the object is placed, and a skill used. The action description 605 may have a format such as <Used hand, Pick object, Place Position, Skill>.

The processor 180 may obtain a plurality of action descriptions corresponding to each of the plurality of sampling images. If the number of image samples is t, the number of action descriptions may also be t.

The processor 180 may obtain a plurality of action descriptions as a second action plan 606. The second action plan 606 may be referred to as video-based sub-goal planning.

Meanwhile, the skill included in the action description 605 may represent a unit action of the artificial intelligence robot 300. The skill may be any one of PICK, PLACE, HOLD, or IDLE, but this is only an example.

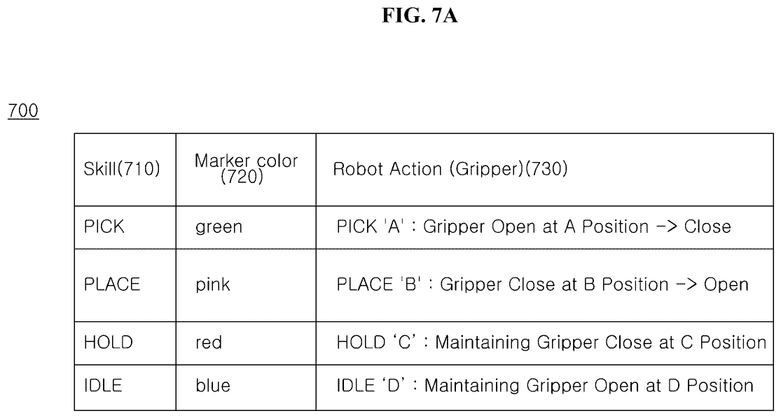

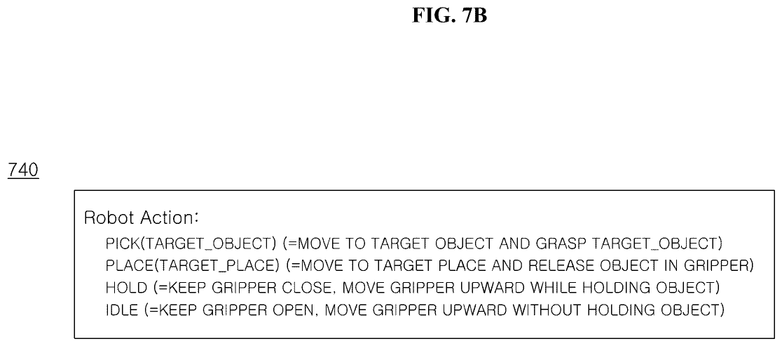

FIGS. 7A and 7B are diagrams illustrating robot skill information representing unit action of an artificial intelligence robot according to an embodiment of the present disclosure.

A first robot skill information 700 may include a skill item 710 of the artificial intelligence robot 300, a marker color item 720, and a robot action item 730.

The skill item 710 may be an item indicating a skill type of the artificial intelligence robot 300.

The skill may be divided into four types. Referring to FIG. 7A, a PICK skill may represent the action of opening the gripper at a position A and then closing the gripper. A PLACE skill may represent the action of opening a closed gripper in a position B. A HOLD skill may represent the action of maintaining a closed state of the gripper in a C position. A IDLE skill may represent the act of maintaining an open state of the gripper in a D position.

The marker color item 720 may indicate the color marked for each skill. PICK skills may be marked in green, PPLACE skills may be marked in pink, HOLD skills may be marked in red, and IDLE skills may be marked in blue.

The robot action item 730 may represent the operation of the gripper corresponding to each skill.

The second robot skill information 740 may include a detailed description of each skill. The second robot skill information 740 may be included in the first robot skill information 700. The second robot skill information 740 may be included in the robot action item 730 of the first robot skill information 700.

Again, FIG. 4 will be described.

The processor 180 of the artificial intelligence device 100 may generate an action plan template based on the first action plan and the second action plan, and store the generated action plan template in the memory 170 (S505).

The processor 180 may generate the action plan template based on the first action plan 603, the second action plan 606, and the robot skill information 700 and 740.

The processor 180 may generate a prompt including the first action plan 603, the second action plan 606, and robot skill information 700 and 740, and input the generated prompt to the LLM. The processor 180 may obtain the action plan template corresponding to the prompt from the LLM. The prompt may be a command to generate the action plan using the first action plan 603, the second action plan 606, and the robot skill information 700 and 740.

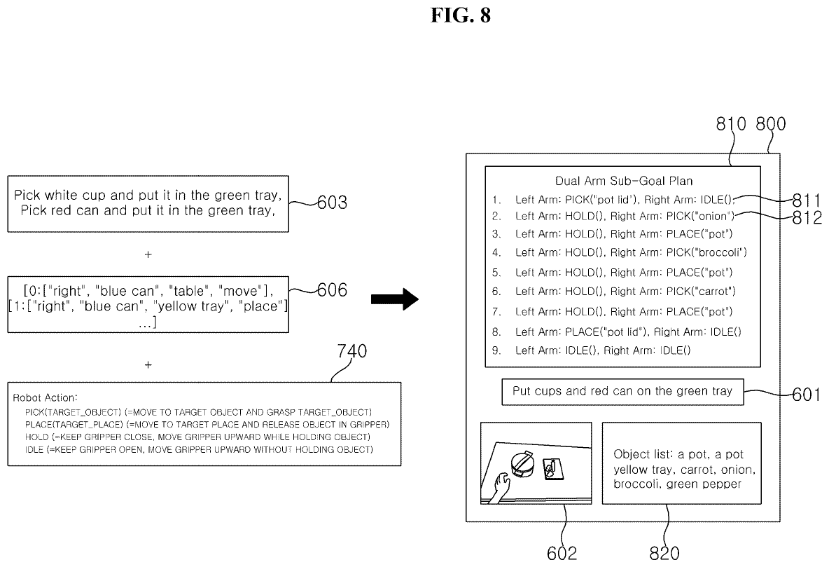

Referring to FIG. 8, an action plan template 800 generated based on the text-based first action plan 603, a video-based action plan 606, and the second robot skill information 740 is shown.

The action plan template 800 may include a dual arm plan 810. The action plan template 800 may further include the text instruction 601, the initial sampling image 602 which is a basis for generating the action plan template 800, and an object list 820.

The action plan template 800 may only include the dual arm plan 810. The memory 170 may store the action plan template 800 by matching it with the text instruction 601, the initial image 6020, and the object list 820.

The dual arm plan 810 may include one or more of a skill type that each of the first arm 320 and the second arm 330 must sequentially perform or a skill target. The dual arm plan 810 may include a plurality of dual arm sub plans.

For example, a first dual arm sub plan 811 may be a plan in which the first arm 320 performs the PICK skill for a pot lid and the second arm 330 performs the IDLE skill. A second dual arm sub plan 812 may be a plan in which the first arm 320 performs the HOLD skill and the second arm 330 performs the PICK skill for an onion.

The object list 820 may include names of objects identified from the initial sampling image 602.

The processor 180 may generate the plurality of action plan templates in this manner and store the generated plurality of action plan templates in the memory 170.

The processor 180 may convert at least one of the text instruction 601 or the initial sampling image 602 into an embedding vector, match the converted embedding vector with the action plan template 800, and store it in the memory 170. The converted embedding vector may be used in a call of the action plan template.

Again, FIG. 4 will be described.

The processor 180 may extract an action plan template that matches the command and the sensing information from among the plurality of action plan templates stored in the memory 170. The processor 180 may convert the command and the sensing information into an embedding vector. The processor 180 may compare the converted embedding vector with embedding vectors stored in the memory 170 to determine an embedding vector that is most similar to the converted embedding vector. The processor 180 may obtain the action plan template that matches the determined embedding vector.

The processor 180 of the artificial intelligence device 100 may generate a robot control command based on the command, the sensing information, and the obtained action plan template (S405), and may control the operations of the first arm 320 and the second arm 330 of the artificial intelligence robot 300 according to the generated robot control command (S407).

The processor 180 may modify the action plan template obtained based on the command and the sensing information, and obtain the modified action plan template as a robot control command. The modified action plan template may include a skill type that each of the first arm 320 and the second arm 330 must sequentially perform and skill target.

The processor 180 may transmit the robot control command to the artificial intelligence robot 300 through the communication interface 110. The artificial intelligence robot 300 may control the motor 340 so that the first arm 320 and the second arm 330 operate according to the received robot control command.

As such, according to an embodiment of the present disclosure, a dual arm robot may follow movements similar to how a person acts according to the operation sequence for the two arms.

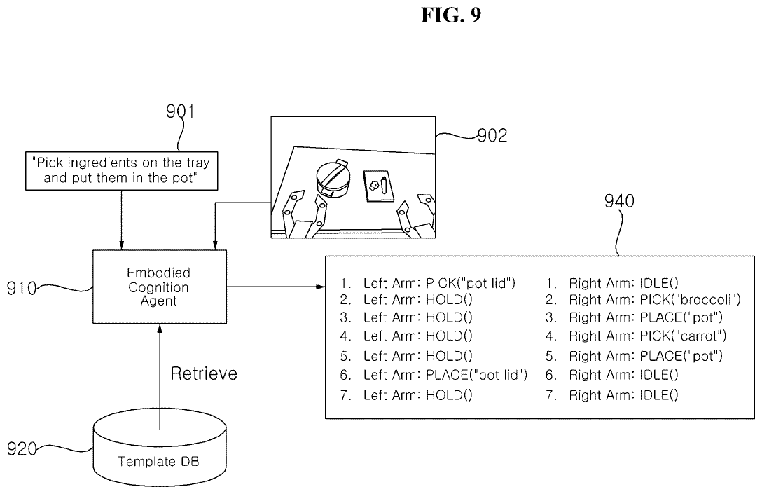

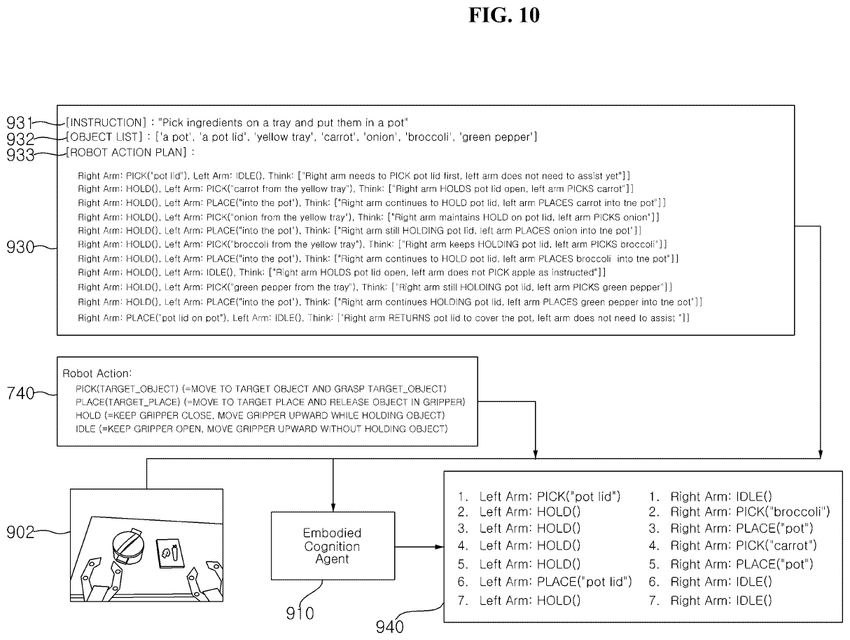

FIGS. 9 and 10 are diagrams illustrating a process for obtaining a modified action plan template corresponding to an instruction and an initial image according to an embodiment of the present disclosure.

Referring to FIG. 9, the artificial intelligence device 100 may obtain a text instruction 901 that say <Pick ingredients on the tray and put them in the pot> and an initial image 902.

The text instruction 901 may be an instruction typed through the user input interface 123. The text instruction 901 may be an instruction obtained by converting the voice obtained through the microphone 122 into a text.

The initial image 902 may be an image acquired through the camera 121 of the artificial intelligence device 100 or the camera 350 of the artificial intelligence robot 300. The initial image 902 may be an image taken before the artificial intelligence robot 300 starts operating. In FIG. 9, the initial image 902 may include a pot with a lid, a carrot, and a broccoli.

Embodied Cognition Agent (ECA) 910 may call an action plan template 930 from a template database 920 based on the text instruction 901 and the initial image 902. The ECA 910 may be hardware or software for calling the action plan template 930 of the artificial intelligence robot 300.

If the ECA 910 is hardware, the ECA 910 may be included in the processor 180.

If the ECA 910 is software, the ECA 910 may be executed by instructions given by the processor 180.

The template database 920 may be included in the memory 170 or may be provided separately. The template database 920 may store the plurality of action plan templates. The template database 920 may store the plurality of action plan templates and a plurality of embedding vectors corresponding to each of the plurality of action plan templates.

The ECA 910 may convert the text instruction 901 and the initial image 902 into an embedding vector. The ECA 910 may compare the converted embedding vector with the plurality of embedding vectors stored in the template database 920, and extract an embedding vector that is most similar to the converted embedding vector among the plurality of embedding vectors.

The ECA 910 may call the action plan template 930 that matches the extracted embedding vector. The action plan template 930 may include a instruction 931, an object list 932, and a dual arm plan 933.

The instruction 931 may be a text instruction input by the user.

The object list 932 may include information about objects extracted from the initial image 902. The object list 932 may include a pot with a lid, a yellow tray, a carrot, an onion, a broccoli, and a green pepper.

The dual arm plan 933 may include a skill type that each of the first arm 320 and the second arm 330 must sequentially perform and skill target.

The ECA 910 may obtain a modified action plan template 940 by modifying the action plan template 930 based on the extracted action plan template 930, the initial image 902, and the second robot skill information 740.

The ECA 910 may compare objects included in the object list 932 of the action plan template 930 with objects included in the initial image 902. As a result of a comparison, the ECA 910 may remove the remaining objects excluding the objects included in the initial image 902 from among the objects included in the object list 932. The ECA 910 may modify the dual arm plan 933 to include only skills for objects included in the initial image 902, and obtain the modified dual arm plan as the modified action plan template 940.

The ECA 910 may obtain the modified action plan template 940 as a robot control command and transmit the obtained robot control command to the artificial intelligence robot 300. The artificial intelligence robot 300 may sequentially control the operations of the first arm 320 and the second arm 330 according to the modified dual arm plan included in the robot control command.

According to another embodiment of the present disclosure, the artificial intelligence device 100 may transmit action trajectory information to the artificial intelligence robot 300 in addition to the robot control command.

The action trajectory information may include information about the movement trajectories of the first arm 320 and the second arm 330 according to the modified dual arm plan. The action trajectory information may be information indicating an action trajectory that the first arm 320 and the second arm 330 must perform according to the modified dual arm plan.

The action trajectory information may include a location of skill performance of each of the first arm 320 and the second arm 330. The location of skill performance may include one or more of the location of the object included in the initial image 902 or the location to which each arm must be moved.

The processor 180 may identify a plurality of objects from the initial image 902 and obtain the location (or coordinates) of each identified object.

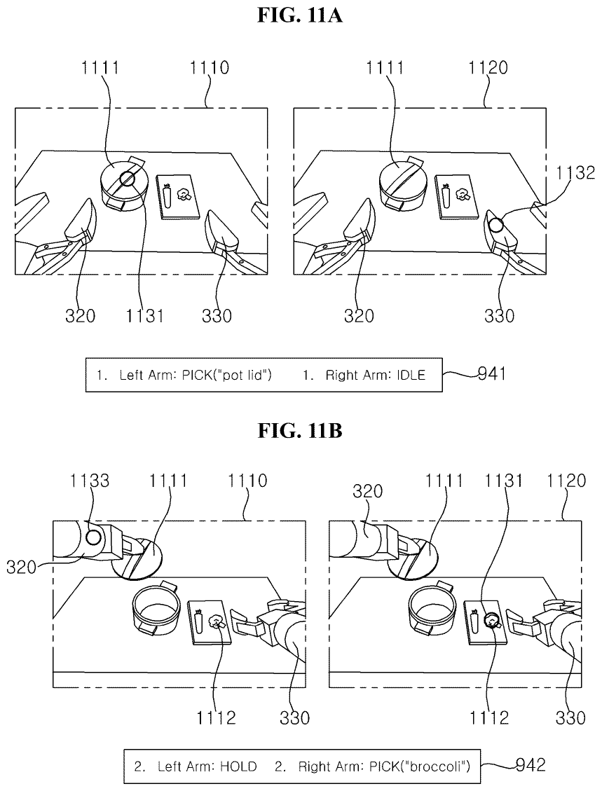

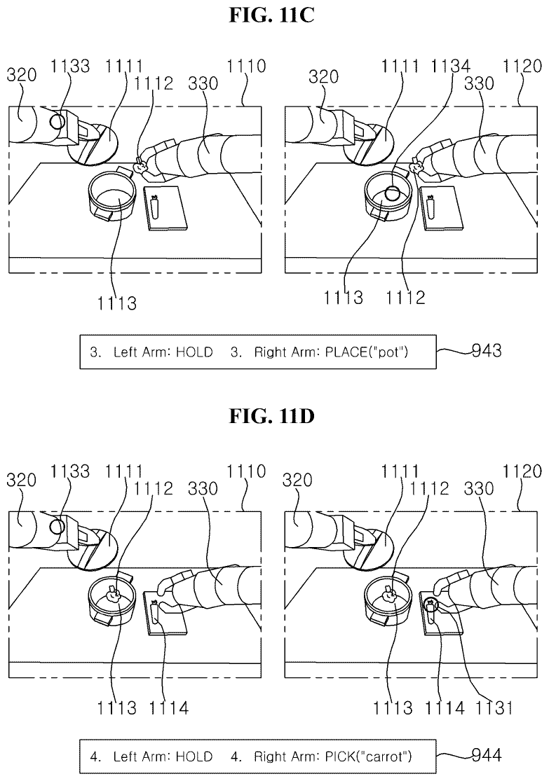

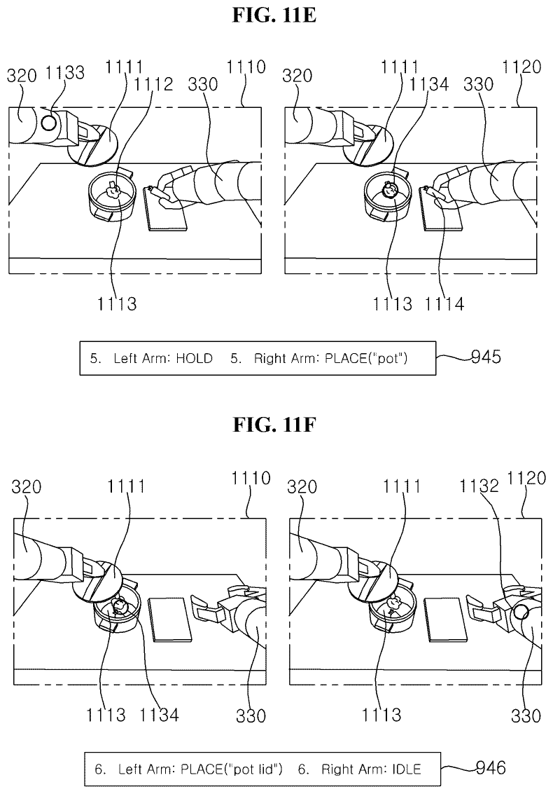

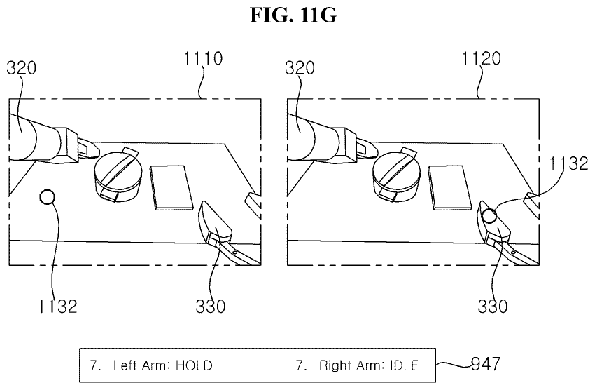

FIGS. 11A to 11G are diagrams illustrating a process in which an artificial intelligence robot performs a task according to robot control commands and action trajectory information.

FIGS. 11A to 11G, it is assumed that the artificial intelligence robot 300 is controlled based on the modified action plan template 940 obtained according to the embodiment of FIGS. 9 and 10.

The robot control command may include a modified action plan template 940 and a message requesting control of the artificial intelligence robot 300 according to the modified action plan template 940.

The modified action plan template 940 may include a plurality of dual arm sub plans 941 to 947. The plurality of dual arm sub plans 941 to 947 may be operations that the artificial intelligence robot 300 must perform sequentially.

Referring to FIGS. 11A to 11G, a first image 1110 and a second image 1120 are shown. The artificial intelligence device 100 may receive the first image 1110 and the second image 1120 from the artificial intelligence robot 300 and display them on the display 151. The first image 1110 and the second image 1120 may be images displayed by a display provided in the artificial intelligence robot 300.

The first image 1110 may be an image from a perspective of the first arm 320 of the artificial intelligence robot 300, and the second image 1120 may be an image from a perspective of the second arm 330 of the artificial intelligence robot 300.

Referring to FIG. 11A, the first dual arm sub plan 941 may be a plan in which the first arm 320 performs the PICK skill for the pot lid 1111 and the second arm 330 performs the IDLE skill.

The artificial intelligence device 100 may display a green marker 1131 on the pot lid 1111 of the first image 1110 based on the position of the pot lid 1111 included in the action trajectory information and the skill type of the first arm 320 included in the first dual arm sub plan 941. The green marker 1131 may be a marker that identifies the object (or the location of the object) to which the PICK skill of the first arm 320 is to be applied.

The artificial intelligence robot 300 may recognize the green marker 1131 and perform the PICK skill on the location corresponding to the green marker 1131 through the first arm 320.

The artificial intelligence device 100 may display a blue marker 1132 on the second arm 330 of the second image 1120 based on the location of the second arm 330 included in the action trajectory information and the skill type of the second arm 330 included in the first dual arm sub plan 941. The blue marker 1132 may be a marker that identifies the location to apply the IDLE skill of the second arm 330. The IDLE skill may be an action that maintains the open state of the second arm 330.

The artificial intelligence robot 300 may recognize the blue marker 1132 and perform the IDLE skill on the location corresponding to the blue marker 1132 through the second arm 330.

Referring to FIG. 11B, the second dual arm sub plan 942 may be a plan in which the first arm 320 performs the HOLD skill and the second arm 330 performs the PICK skill for broccoli 1112.

The artificial intelligence device 100 may display a red marker 1133 on the first arm 320 of the first image 1110 based on the position of the first arm 320 included in the action trajectory information and the skill type of the first arm 320 included in the second dual arm sub plan 942. The red marker 1133 may be a marker that identifies the location to apply the HOLD skill of the first arm 320.

The artificial intelligence robot 300 may recognize the red marker 1133 and perform the HOLD skill at a position corresponding to the red marker 1133 through the first arm 320.

The artificial intelligence device 100 may display a green marker 1131 on the broccoli 1112 of the second image 1120 based on the location of the broccoli 1112 included in the action trajectory information and the skill type of the second arm 330 included in the second dual arm sub plan 942. The green marker 1131 may be a marker that identifies the location of the object to which the PICK skill of the second arm 330 is to be applied.

The artificial intelligence robot 300 may recognize the green marker 1131 and perform a PICK skill at a location corresponding to the green marker 1131 through the second arm 330.

Referring to FIG. 11C, the third dual arm sub plan 943 may be a plan in which the first arm 320 performs the HOLD skill and the second arm 330 performs the PLACE skill for the pot 1113.

The artificial intelligence device 100 may display a red marker 1133 on the first arm 320 of the first image 1110 based on the position of the first arm 320 included in the action trajectory information and the skill type of the first arm 320 included in the third dual arm sub plan 943. The red marker 1133 may be a marker that identifies the location to apply the HOLD skill of the first arm 320.

The artificial intelligence robot 300 may recognize the red marker 1133 and perform the HOLD skill at a position corresponding to the red marker 1133 through the first arm 320.

The artificial intelligence device 100 may display a pink marker 1134 on the pot 1113 of the second image 1120 based on the location of the pot 1113 included in the action trajectory information and the skill type of the second arm 330 included in the third dual arm sub plan 943. The pink marker 1134 may be a marker that identifies the location of the object to which the PLACE skill of the second arm 330 is to be applied.

The artificial intelligence robot 300 may recognize the pink marker 1134 and perform the PLACE skill at a location corresponding to the pink marker 1134 through the second arm 330.

Referring to FIG. 11D, the fourth dual arm sub plan 944 may be a plan in which the first arm 320 performs the HOLD skill and the second arm 330 performs the PICK skill for the carrot 1114.

The artificial intelligence device 100 may display the red marker 1133 on the first arm 320 of the first image 1110 based on the position of the first arm 320 included in the action trajectory information and the skill type of the first arm 320 included in the fourth dual arm sub plan 944. The red marker 1133 may be a marker that identifies the location to apply the HOLD skill of the first arm 320.

The artificial intelligence robot 300 may recognize the red marker 1133 and perform the HOLD skill at a position corresponding to the red marker 1133 through the first arm 320.

The artificial intelligence device 100 may display the green marker 1131 on the carrot 1113 of the second image 1120 based on the position of the carrot 1114 included in the action trajectory information and the skill type of the second arm 330 included in the fourth dual arm sub plan 944.

The artificial intelligence robot 300 may recognize the green marker 1131 and perform a PICK skill at a location corresponding to the green marker 1131 through the second arm 330.

Referring to FIG. 11E, the fifth dual arm sub plan 945 may be a plan in which the first arm 320 performs the HOLD skill and the second arm 330 performs the PLACE skill for the pot 1113.

The artificial intelligence device 100 may display the red marker 1133 on the first arm 320 of the first image 1110 based on the position of the first arm 320 included in the action trajectory information and the skill type of the first arm 320 included in the fifth dual arm sub plan 945. The red marker 1133 may be a marker that identifies the location to apply the HOLD skill of the first arm 320.

The artificial intelligence robot 300 may recognize the red marker 1133 and perform the HOLD skill at a position corresponding to the red marker 1133 through the first arm 320.

The artificial intelligence device 100 may display the pink marker 1134 on the pot 1113 of the second image 1120 based on the location of the pot 1113 included in the action trajectory information and the skill type of the second arm 330 included in the fifth dual arm sub plan 945. The pink marker 1134 may be a marker that identifies the location of the object to which the PLACE skill of the second arm 330 is to be applied.

The artificial intelligence robot 300 may recognize the pink marker 1134 and perform the PLACE skill at a location corresponding to the pink marker 1134 through the second arm 330.

Referring to FIG. 11F, the sixth dual arm sub plan 946 may be a plan in which the first arm 320 performs the PICK skill for the pot lid 1111 and the second arm 330 performs the IDLE skill.

The artificial intelligence device 100 may display the pink marker 1134 on the pot 1113 of the first image 1110 based on the position of the pot lid 1111 included in the action trajectory information and the skill type of the first arm 320 included in the sixth dual arm sub plan 946.

The artificial intelligence robot 300 may recognize the pink marker 1134 and perform the PLACE skill at a location corresponding to the pink marker 1134 through the first arm 320.

The artificial intelligence device 100 may display the blue marker 1132 on the second arm 330 of the second image 1120 based on the location of the second arm 330 included in the action trajectory information and the skill type of the second arm 330 included in the sixth dual arm sub plan 946. The blue marker 1132 may be a marker that identifies the location to apply the IDLE skill of the second arm 330. The IDLE skill may be an action that maintains the open state of the second arm 330.

The artificial intelligence robot 300 may recognize the blue marker 1132 and perform the IDLE skill at a location corresponding to the blue marker 1132 through the second arm 330.

Referring to FIG. 11G, the seventh dual arm sub plan 947 may be a plan in which the first arm 320 performs the IDLE skill and the second arm 330 performs the IDLE skill.

The artificial intelligence device 100 may display the blue marker 1132 on the first image 1110 based on the position of the first arm 330 included in the action trajectory information and the skill type of the first arm 320 included in the seventh dual arm sub plan 947.

The artificial intelligence robot 300 may recognize the blue marker 1132 and perform the IDLE skill at a location corresponding to the blue marker 1132 through the first arm 320.

The artificial intelligence device 100 may display the blue marker 1132 on the second image 1120 based on the location of the second arm 330 included in the action trajectory information and the skill type of the second arm 330 included in the seventh dual arm sub plan 947. The blue marker 1132 may be a marker that identifies the location to apply the IDLE skill of the second arm 330. The IDLE skill may be an action that maintains the open state of the second arm 330.

The artificial intelligence robot 300 may recognize the blue marker 1132 and perform the IDLE skill at a location corresponding to the blue marker 1132 through the second arm 330.

As such, according to an embodiment of the present disclosure, the artificial intelligence robot 300 may operate in a manner similar to the manner in which a human operates. Accordingly, tasks to be performed by the human may be performed by the artificial intelligence robot 300, thereby greatly improving task automation, productivity, and stability.

The artificial intelligence device 100 according to an embodiment of the present disclosure may comprise a memory 170 configured to store a plurality of action plan templates; and at least one processor 180 configured to: obtain a command and an initial image, obtain an action plan template among the plurality of action plan templates based on the obtained command and initial image, generate a robot control command from the command, the initial image and the obtained action plan template, and control both arms of a robot through the generated robot control command.

The at least one processor 180 may modify the action plan template based on the command and the initial image, and obtain the modified action plan template as the robot control command.

The at least one processor 180 may generate a first action plan based on a text instruction, generate a second action plan based on a human demonstration video, generate the action plan template based on the first action plan and the second action plan, and store the generated action plan template in the memory.

The at least one processor 180 may generate the first action plan from the text instruction and an initial sampling image sampled from the human demonstration video using a Large Language Model (LLM).

The at least one processor 180 may obtain a plurality of action descriptions from each of a plurality of sampling images sampled from the human demonstration video, and obtain the plurality of action descriptions as the second action plan.

The at least one processor 180 may generate the action plan template based on the first action plan, the second action plan, and robot skill information, the robot skill information may include information about skills performed by a first arm and a second arm of the robot.

The action plan template may include the text instruction, the initial sampling image, and a skill type that each of the first arm and the second arm of the robot must perform.

The at least one processor 180 may transmit, to the robot, the robot control command and action trajectory information about the movement trajectories of both arms of the robot.

The action trajectory information may include a location of skill performance of each of a first arm and a second arm of the robot.

The memory 170 may store a plurality of embedding vectors corresponding to each of the plurality of action plan templates, and the at least one processor 180 may convert the command and the initial image into an embedding vector, extract an embedding vector most similar to the converted embedding vector among the plurality of embedding vectors, and obtain the action plan template corresponding to the extracted embedding vector.

The present disclosure described above may be implemented as computer-readable code on a program-recorded medium. Computer-readable media includes all types of recording devices that store data that may be read by a computer system. Examples of computer-readable media include hard disk drives (HDDs), solid state disks (SSDs), silicon disk drives (SDDs), ROMs, RAMs, CD-ROMs, magnetic tapes, floppy disks, and optical data storage devices. Additionally, the computer may include a processor 180 of an artificial intelligence device.

What is claimed is:

1. An artificial intelligence device, comprising:
a memory configured to store a plurality of action plan templates; and
at least one processor configured to:
obtain a command and an initial image,
obtain an action plan template among the plurality of action plan templates based on the obtained command and initial image,
generate a robot control command from the command, the initial image and the obtained action plan template, and
control both arms of a robot through the generated robot control command.

2. The artificial intelligence device of the claim 1, wherein the at least one processor is further configured to:
modify the action plan template based on the command and the initial image, and
obtain the modified action plan template as the robot control command.

3. The artificial intelligence device of the claim 1, wherein the at least one processor is further configured to:
generate a first action plan based on a text instruction,
generate a second action plan based on a human demonstration video,
generate the action plan template based on the first action plan and the second action plan, and
store the generated action plan template in the memory.

4. The artificial intelligence device of the claim 3, wherein the at least one processor is configured to:
generate the first action plan from the text instruction and an initial sampling image sampled from the human demonstration video using a Large Language Model (LLM).

5. The artificial intelligence device of the claim 4, wherein the at least one processor is configured to:
obtain a plurality of action descriptions from each of a plurality of sampling images sampled from the human demonstration video, and
obtain the plurality of action descriptions as the second action plan.

6. The artificial intelligence device of the claim 3, wherein the at least one processor is configured to:
generate the action plan template based on the first action plan, the second action plan, and robot skill information,
wherein the robot skill information includes information about skills performed by a first arm and a second arm of the robot.

7. The artificial intelligence device of the claim 4, wherein the action plan template includes the text instruction, the initial sampling image, and a skill type that each of the first arm and the second arm of the robot must perform.

8. The artificial intelligence device of the claim 1, wherein the at least one processor is configured to:
transmit, to the robot, the robot control command and action trajectory information about the movement trajectories of both arms of the robot.

9. The artificial intelligence device of the claim 8, wherein the action trajectory information includes a location of skill performance of each of a first arm and a second arm of the robot.

10. The artificial intelligence device of the claim 1, wherein the memory is configured to store a plurality of embedding vectors corresponding to each of the plurality of action plan templates, and
wherein the at least one processor is configured to:
convert the command and the initial image into an embedding vector,
extract an embedding vector most similar to the converted embedding vector among the plurality of embedding vectors, and
obtain the action plan template corresponding to the extracted embedding vector.

11. A method of operating an artificial intelligence device, the method comprising:
storing a plurality of action plan templates;
obtaining a command and an initial image;
obtaining an action plan template among the plurality of action plan templates based on the obtained command and initial image;
generating a robot control command from the command, the initial image and the obtained action plan template; and
controlling both arms of a robot through the generated robot control command.

12. The method of claim 11, wherein the step of generating the robot control command comprises:
modifying the action plan template based on the command and the initial image, and
obtaining the modified action plan template as the robot control command.

13. The method of claim 11, wherein the step of storing the plurality of action plan templates comprises:
generating a first action plan based on a text instruction,
generating a second action plan based on a human demonstration video,
generating the action plan template based on the first action plan and the second action plan, and
storing the generated action plan template.

14. The method of claim 13, wherein the step of generating the first action plan comprises:
generating the first action plan from the text instruction and an initial sampling image sampled from the human demonstration video using a Large Language Model (LLM).

15. The method of claim 14, wherein the step of generating the second action plan comprises:
obtaining a plurality of action descriptions from each of a plurality of sampling images sampled from the human demonstration video, and
obtaining the plurality of action descriptions as the second action plan.

16. The method of claim 13, wherein the step of generating the action plan template comprises:
generating the action plan template based on the first action plan, the second action plan, and robot skill information,
wherein the robot skill information includes information about skills performed by a first arm and a second arm of the robot.

17. The method of claim 14, wherein the action plan template includes the text instruction, the initial sampling image, and a skill type that each of the first arm and the second arm of the robot must perform.

18. The method of claim 11, further comprising:
transmitting, to the robot, the robot control command and action trajectory information about the movement trajectories of both arms of the robot,
wherein the action trajectory information includes a location of skill performance of each of a first arm and a second arm of the robot.

19. The method of claim 11, further comprising:
storing a plurality of embedding vectors corresponding to each of the plurality of action plan templates, and
converting the command and the initial image into an embedding vector,
extracting an embedding vector most similar to the converted embedding vector among the plurality of embedding vectors, and
obtaining the action plan template corresponding to the extracted embedding vector.

20. A computer-readable non-transitory recording medium on which a program for performing a method of operating an artificial intelligence device is recorded,
wherein the method comprises:
storing a plurality of action plan templates;
obtaining a command and an initial image;
obtaining an action plan template among the plurality of action plan templates based on the obtained command and initial image;
generating a robot control command from the command, the initial image and the obtained action plan template; and
controlling both arms of a robot through the generated robot control command.
